(19) United States
(12) Patent Application Publication
(10) Pub. No.: US 2014/0272153 A1
(43) Pub. Date: Sep. 18, 2014

(54) FREE STANDING POLYMERIC FILMS

(71) Applicant: William J. Buehne, Highland, IN (US)

(72) Inventor: William J. Buehne, Highland, IN (US)

(21) Appl. No.: 14/203,998

(22) Filed: Mar. 11, 2014

Related U.S. Application Data
(60) Provisional application No. 61/778,576, filed on Mar. 13, 2013.

(51) Int. Cl. C09D 127/16

(52) U.S. Cl. CPC C09D 127/16
USPC 427/375; 524/520; 427/385.5; 264/165

(57) ABSTRACT

Polymeric compositions comprising polyvinylidene fluoride and one or more acrylic components are described. The compositions can be formed into films which do not require a carrier or other backing. Also described are methods for forming the films and applications for the films.

### CROSS REFERENCE TO RELATED APPLICATIONS

The present application claims priority to and the benefit of the filing date of U.S. Provisional Application No. 61/778,576 entitled “Free Standing Polymeric Films,” filed on Mar. 13, 2013, the entire disclosure of which is incorporated herein by reference.

### FIELD

The present subject matter relates to free standing polymeric films which can be provided without a carrier or other backing. In certain versions, the subject matter relates to free standing composite films that include polyvinylidene fluoride (PVDF) and acrylic materials.

### BACKGROUND

Polyvinyl fluoride films are used in a wide range of applications in view of their durability and excellent resistance to environmental factors such as moisture and exposure to UV light. Although various polyvinyl fluoride films are commercially available, a need exists for additional alternatives.

Certain polyvinyl fluoride films such as PVDF/acrylic films can become brittle after prolonged periods of time. This is due to crystallization of the polyvinylidene fluoride within the film. Hence, these films are typically provided in conjunction with a carrier such as a polyethylene terephthalate (PET) carrier to provide support for the film. Providing a carrier increases processing complexity and thus cost associated with the PVDF films. Thus, it would be beneficial to provide a PVDF film which was less prone to crystallization and thus which did not require a carrier or other support.

### SUMMARY

The difficulties and drawbacks associated with previously known films are addressed in the present compositions, films, related methods, and articles associated with an unsupported or free standing PVDF/acrylic film.

In one aspect, the present subject matter provides a composition comprising from 50% to 99% of at least one polyvinylidene fluoride polymer. The composition also comprises from 1% to 50% of at least one acrylic component. The composition also comprises from 0% to 5% of at least one supplemental resin. The composition also comprises from 0% to 15% of at least one plasticizer. And, the composition additionally includes an effective amount of solvent.

In another aspect, the present subject matter provides a method for forming a polyvinylidene fluoride film. The method comprises providing a composition including from 50% to 99% of at least one polyvinylidene fluoride polymer, from 1% to 50% of at least one acrylic component, from 0% to 5% of at least one supplemental resin, from 0% to 15% of at least one plasticizer, and an effective amount of solvent. The method also comprises providing a substrate defining at least one face. The method additionally comprises forming a layer of the composition on the face of the substrate. And, the method also comprises performing at least one of drying and fusing of the layer to thereby form the polyvinylidene fluoride film.

In yet another aspect, the present subject matter also provides films formed from the previously noted methods.

In still another aspect, the present subject matter provides an unsupported film free of a carrier. The film includes a cured composition. The composition prior to curing has from 50% to 99% of at least one polyvinylidene fluoride polymer and from 1% to 50% of at least one acrylic component. The film has a thickness in a range of from 0.1 mil to 5 mil and can undergo an elongation of up to 5% without breaking or fracturing.

In still another aspect, the present subject matter provides a photovoltaic backsheet comprising a cured composition. The composition prior to curing includes from 50% to 99% of at least one polyvinylidene fluoride polymer, from 1% to 50% of at least one acrylic component, from 0% to 5% of at least one supplemental resin, and from 0% to 15% of at least one plasticizer.

As will be realized, the subject matter is capable of other and different embodiments and its several details are capable of modifications in various respects, all without departing from the subject matter. Accordingly, the drawings and description are to be regarded as illustrative and not restrictive.

### BRIEF DESCRIPTION OF THE DRAWINGS

FIG. 1 is a process schematic flowchart illustrating a method for forming an unsupported film in accordance with the present subject matter.

### DETAILED DESCRIPTION OF THE EMBODIMENTS

Generally, the present subject matter provides compositions that can be formed into free standing or unsupported films. The terms “free standing” or “unsupported” as used herein refer to films which do not require a carrier sheet or film. That is, these terms refer to films that can be stored, shipped, and otherwise processed without a carrier sheet or film. The films of the present subject matter exhibit sufficient flexibility even after prolonged time periods such as up to a week, 1 month, 3 months, 6 months, and in certain instances 1 year and longer, so that the films are not excessively brittle and prone to fracture or cracking. Although the present subject matter is generally directed to free standing films, the subject matter includes films which are provided on a carrier or other support. The present subject matter also provides films and film assemblies formed from the compositions described herein. And, the present subject matter additionally comprises laminates or other products or articles using or formed from the compositions and/or films described herein. Furthermore, the present subject matter also provides various methods of producing the free standing films. These and other aspects are all described herein.

### Compositions

The present subject matter provides compositions as generally set forth in Table 1 as follows. All percentages noted herein are percentages by weight unless indicated otherwise.

TABLE 1
Compositions According to Present Subject Matter

| | Amounts | | |
|---|---|---|---|
| Component | Generally | Typically | Specifically |
| PVDF | 50-99% | 60-90% | 65-85% |
| Acrylic Resin | 1-50% | 10-40% | 15-35% |
| Supplemental Resin | 0-5% | 1-5% | 1-3% |
| Plasticizer | 0-15% | 0-10% | 0.1-10% |
| Pigment | 0-25% | 0-20% | 0-18% |
| Solvent | Varies | Varies | Varies |

### Polyvinylidene Fluoride

A wide range of PVDF resins can be used. The PVDF resins include but are not limited to copolymers of vinylidene fluoride and hexafluoropropylene. Corresponding homopolymers of PVDF can be used. An example of a suitable commercially available PVDF resin is Kynar 2824 available from Arkema Inc. of North America. Examples of commercially available copolymer PVDF resins include those available from Arkema of Philadelphia, Pa. Examples of commercially available homopolymer PVDF resins include those from Arkema. Additional examples of commercially available PVDF resins include FSF301, Kynar 500 plus and Kynar 7201F from Arkema. All of these can be used separately or in combination with one another or with other resin(s). FSF301 and Kynar 500 plus are PVDF homopolymers. And Kynar 7201F is a PVDF copolymer.

It is also contemplated that a commercially available grade of a homopolymer PVDF generally known in the industry as HTG could be used. These PVDF homopolymers are available from Solvay.

In certain applications, nearly any type of polyvinyl fluoride (PVF) resin can be used in place of the noted PVDF resin(s) or in combination with the PVDF resin(s).

Polyvinyl fluoride is a well known synthetic resin which can be prepared as described in U.S. Pat. No. 3,139,207 and can be manufactured in oriented film form as described in U.S. Pat. No. 3,139,470. As used herein, the term “polyvinyl fluoride” includes homopolymers of vinyl fluoride and also embraces copolymers of vinyl fluoride with other monoethylenically unsaturated monomers copolymerizable therewith, wherein vinyl fluoride constitutes at least 75% of the total copolymer weight. Representative monoethylenically unsaturated monomers useful for this purpose include vinyl esters, such as acetate and stearate, acrylates and methacrylates, such as methyl, ethyl butyl and isobutylene methacrylate. Other useful monomers are listed in aforementioned U.S. Pat. No. 3,139,470.

### Acrylic Component

A wide range of acrylic polymers and/or resins can be used. Preferably the acrylic polymer is formed from one or more of the following: methyl methacrylate, ethyl methacrylate, n-butyl methacrylate, iso-butyl methacrylate, hydroxyethyl methacrylate, and methacrylic acid. An example of a preferred material for use as the acrylic component is B-72 from Rohm and Haas. Elvacite 2008, 2042, 2043 and 2899 can also be used and are from Lucite International. Doresco AC27-43 is another example of a commercially available acrylic resin, from Dock Resins. All are ethyl methacrylate type resins.

In certain applications, the acrylic component includes polymers derived from one or more hydroxy functional ethylenically unsaturated monomers containing either primary or secondary hydroxyl groups. These monomers include hydroxy alkyl (meth)acrylates having 1-4 carbon atoms in the alkyl groups, such as hydroxy methyl acrylate, hydroxy methylmethacrylate, hydroxy ethylacrylate, hydroxy ethyl methacrylate, hydroxy propyl methacrylate, hydroxy propyl acrylate, hydroxy butyl acrylate, hydroxy butyl methacrylate and the like.

### Supplemental Resin

The present subject matter compositions may also optionally comprise one or more supplemental resins. Nonlimiting examples of the supplemental resins include cellulose materials, polyvinyl chloride (PVC) materials, urethanes and polyurethanes, and combinations thereof. Nonlimiting examples of a cellusic polymer is cellulose acetate butyrate. This agent is commercially available such as under the designation CAB 381.5 from Eastman Chemical. Other cellulose derivatives may also be suitable such as cellulose acetate phthalate which is available from Eastman under the designation CAP 482.5.

### Plasticizer

A wide array of plasticizers can be used. Representative examples of plasticizers include but are not limited to butyl benzyl phthalate (BBP), dimethyl phthalate (DMP), and dibutyl phthalate (DBP). Other phthalate based plasticizers can be used. Moreover, the present subject matter includes the use of non-phthalate based plasticizers. Nonlimiting examples of commercially available plasticizers include Edenol 9790 from Emery Oleochemicals, Paraplex A-8210 from HallStar, and Santicizer Platinum P1400 from Ferro Corporation.

Although the use of plasticizer as described as optional, in many applications it may be appropriate to utilize at least about 1% plasticizer. The use of such has been found to reduce brittleness in the resulting film. Undesirable consequences such as fracturing of the film can occur during processing if the film is too brittle.

### Pigment

A wide array of pigments can be used in the present subject matter compositions. The pigment can be any inorganic or organic pigment necessary to achieve a desired color and/or opacity. An example of a potentially useful pigment is titanium dioxide or mica. The use of pigment is optional. For example, if a clear, colorless film is desired, the inclusion of pigment in the composition is generally avoided.

The particular amount of pigment that is incorporated into the composition depends upon several factors. For example, the use of pigment may depend upon the color, opacity and thickness requirements of the film or product. The lower limit is basically 0% pigment, which produces a clear or hazy film, depending upon the formulation of the composition. The upper limit is dependent upon when the critical pigment volume concentration (CPVC) is obtained. At that point, the physical properties of the film typically begin to degrade. Generally, the CPVC can be higher than 18%, as noted in Table 1 and up to about 25%. Thus, a suitable range for pigment may be from 0.1% to 25%.

Pigment particles are typically provided in conjunction with a binder. For example, suitably, mica may be used, up to a pigment to binder ratio of 1.1 to 1, to help reduce the moisture vapor transmission rate. Nano particle titanium dioxide (Ti0₂) may be used, up to a pigment to binder ratio of 1.1 to 1, to block UV light transmission. However, the compositions can utilize pigment in a wide range of pigment to binder ratios. Typically, the amount of pigment is from about 0.1 to about 1.1, more particularly from about 0.5 to about 0.9, and more particularly from about 0.6 to about 0.7, expressed as a weight ratio of pigment to binder. Nearly any type of pigment and associated binder can be used such that the pigment and binder are compatible and appropriate for the end use application.

When using titanium dioxide pigment, it is preferred to provide such in the form of a pigment dispersion. Various solvents or liquid vehicles can be used in conjunction with the titanium dioxide pigment. Preferred examples include but are not limited to propylene glycol monomethyl ether acetate (PMAC), xylene, and combinations thereof. One or more dispersants may also be used, which are described in greater detail herein. An example of a titanium dioxide dispersion is a pigment dispersion comprising about 100 parts by weight of titanium dioxide pigment, about 50 parts by weight of PMAC, about 50 parts by weight xylene, and about 0.3 parts by weight of dispersant. A preferred commercially available titanium dioxide is Ti-Pure R-960 from DuPont.

### Solvent

The solvent choice generally depends on the resins used. Nonlimiting examples of solvents include cyclohexanone (CYC), butyrolactone, pentyl proprionate, diisobutyl ketone (DIBK), methyl propyl ketone (MPK), and combinations thereof. A particular butyrolactone is n-butyrolactone (BLO). Additional examples of solvents include acetate ester solvent and 2,4-pentane dione. For solution grade resins strong solvents such as ketones are used. The choice of ketones typically depends on the equipment being used to coat and dry the material. If dispersion grade resins are used, then other solvents can be used. These other solvents should be weak enough to allow the dispersion grade resins to not be solvated in the solution, but with a strong tail to allow film formation during drying.

In certain embodiments, mixtures of branched and linear alkyl acetate solvents can be used. For example, a mixture of primarily seven carbon alkyl acetate esters can be used. These solvents and similar solvents were previously commercially available from ExxonMobil Chemical Co. under the designation Exxate 700.

In certain embodiments, a combination of solvents is utilized. The selection of solvents and/or combination of solvents typically depends upon the resin system used. For a homopolymer PVDF dispersion grade resin, a combination of cyclohexanone/butyrolactone/pentyl propionate/diisobutyl ketone in a weight proportion of 40/30/20/10 is appropriate. For a solution grade copolymer PVDF resin system, a 50/50 blend of methyl propyl ketone/cyclohexanone is appropriate. This combination is well suited for a 3 roll reverse roll coater for which a composition viscosity between 600 and 1000 centipoise is beneficial. The amount of solvent incorporated in the compositions is generally referred to herein as an effective amount. The term “effective amount” as used herein with regard to the solvent refers to an amount that facilitates mixing and/or blending of the components, and which also enables the desired processing operations to be performed such as for example forming coatings or liquid layers of the compositions during the production of films or sheet products.

### Additional Components

One or more dispersants can be included in the compositions to facilitate blending or mixing of the components. Nonlimiting examples of such dispersants include those available from King Industries Specialty Chemicals under the designation K-SPERSE, such as K-SPERSE 131. Other commercially available dispersants are those from Lubrizol Corporation under the designation Solsperse, such as Solsperse 17000 or Solsperse 32000.

The composition may also comprise one or more catalysts, stabilizers, antioxidants, processing aids, blocking agents, and/or thermal stabilizers. Various catalysts can be included in the compositions. A preferred catalyst is p-toluenesulfonic acid (PTSA). This catalyst is commercially available from numerous sources such as from Cytec Industries under the designation Cycat 4040. Various light stabilizers can also be included in the coating composition. A preferred light stabilizer is a UV absorber such as Tinuvin 928 available from Ciba Specialty Chemicals (BASF). Tinuvin 928 is 2-(2H-Benzotriazole-2-yl)-6-(1-methyl-1-phenylethyl)-4-(1,1,3,3-tetramethylbutyl)phenol. Another material also available from Ciba/BASF can be used, Tinuvin 384. Tinuvin 384 is believed to be 95% benzenepropanoic acid, 3-(2H-benzotriazol-2-yl)-5-(1,1-dimethylethyl)-4-hydroxy-, C7-9-branched and linear alkyl esters and 5% 1-methoxy-2-propyl acetate. Tinuvin 234 (T-234) is also useful. Tinuvin 234 is phenol, 2-(2H-benzotriazol-2-yl)-4,6-bis(1-methyl-1-phenylethyl). The compositions can also include one or more antioxidants such as those commercially available from Ciba Specialty Chemicals/BASF under the designation Irganox, and specifically Irganox 1076, 1010, 245. In addition, antioxidants from Cytec can be used such as Cyanox 1790. In addition, various processing aids and thermal stabilizers can be included in the coating compositions. Examples of these include Irganox 126 and Irganox B225, both commercially available from Ciba Specialty Chemicals/BASF.

The resulting films, backsheets, coatings, and other articles produced from the compositions described herein may optionally include one or more crosslinking agents. Although in many versions of the present subject matter, the compositions are not crosslinked or substantially free of crosslinking, the subject matter includes crosslinked compositions. Thus, one or more crosslinking agents can optionally be included in the compositions. A number of useful crosslinking agents for the composition are known, and include, for example, aminoplast resins such as melamine formaldehyde resins, including monomeric or polymeric melamine resin and partially or fully alkylated melamine resin. Suitable crosslinking agents include hexamethylol melamine, pentamethylol melamine, tetramethylol melamine, etc. These are made by reacting 6 or less moles of formaldehyde with each mole of melamine. The reaction causes the addition of hydroxymethyl groups to the amine groups of the melamine resin. The fully or partially methylolated melamine may also be fully or partially alkylated by reacting with an alcohol, such as methanol. Suitable melamine resins include those hydrophilic melamines and/or hydrophobic melamines, such as, for example, CYMEL® 303, CYMEL® 325, CYMEL® 1156, manufactured by Cytec; YUBAN 20N, YUBAN 20SB, YUBAN 128, manufactured by Mitsui Toatsu Chemicals, Inc.; SUMIMAL® M-50W, SUMIMAL® M-40N, SUMIMA®L M-30W, manufactured by Sumitomo Chemical Co. Ltd, and the like, used alone or in combinations. A particularly useful crosslinking agent is CYMEL® 303, a hexamethoxymethylmelamine resin, commercially available from Cytec. A curing catalyst is typically added to catalyze the curing (i.e., crosslinking) reactions between the reactive components in the formulation. For example, when melamines are used as the crosslinking agent, a strong acid catalyst may be used to enhance the cure reaction. Such catalysts are well-known and include, without limitation, p-toluenesulfonic acid, dinonylnapthalene disulfonic acid, dodecylbenzenesulfonic acid, phenyl acid phosphate, monobutyl maleate, butyl phosphate, and hydroxy phosphate ester. Any mixture of the foregoing catalysts may be useful. In general, the catalyst is used in the amount of about 0.1 to 5%.

### Methods

Polymeric films or thin layers can be prepared from the present subject matter compositions using various techniques. Typically, an effective amount of the composition is applied or otherwise deposited onto a substrate or conventional carrier. The composition can be applied to a face of the substrate. If a carrier is used, after drying and/or curing of the film, the carrier is then removed. This is possible due to the surprising and unexpected properties of the film which enables its use in unsupported applications. Specifically, the formulation can be coated onto a PET carrier using a 3 roll reverse roll coater. Other methods can be used such as slot die coaters, knife over roll coaters, Meyer rod coaters, comma coaters, or any other coating method. The layered intermediate product is then directed through an oven in which the material is dried or fused into a film. The resulting roll of material can then be slit or trimmed to size and the film removed from the carrier to form a roll of product. Typical oven processing conditions utilize temperatures from about 280° F. (138° C.) to about 370° F. (188° C.) for time periods from about 1 minute to about 5 minutes.

Coating weight can vary depending upon the application. Typical coat weights are within a range of from 20 gsm (grams/m²) to 275 gsm, and more particularly from 80 gsm to 120 gsm.

In a suitable embodiment, the coating or film thickness is in the range of about 0.1 mil to about 5 mil. In yet another suitable embodiment, the coating or film thickness is in the range of about 0.25 mil to about 3.0 mil. In yet another suitable embodiment, the coating thickness or coating weight is in the range of about 1.50 mil to about 2.50 mil. In still a further suitable embodiment, the coating thickness or coating weight is about 1.80 to 2.0 mil.

FIG. 1 is a schematic flow chart of a method 100 for forming an unsupported film in accordance with the present subject matter. The method 100 comprises providing a composition as described herein. That operation is denoted as 10 in FIG. 1. The method 100 also comprises an operation 20 of providing a substrate. The substrate defines at least one face or surface for receiving the composition. In operation 30, a layer of the composition is formed on the substrate and particularly on the face of the substrate. Next, in operation 40, the layer is subjected to a drying and/or fusing operation as described herein to form a film on the substrate. And, in operation 50, the film is removed or otherwise separated from the substrate to thereby obtain the film in an unsupported state or condition. The unsupported film can then be wound into a roll form or cut in sheet form.

### Applications and Products

The films can be used in a wide range of applications such as, but not limited to, graphic labels, address labels, battery labels, films in multilayered laminate assemblies, and as hard coatings including clear coats and color coats. In addition, the films can be used in photovoltaic backsheets or in nearly any application in which TEDLAR is used. TEDLAR is a polyvinyl fluoride film available from DuPont. TEDLAR is widely used as a backsheet material for photovoltaic solar modules. The present subject matter films may also be suitable for protective film applications such as those in which KORAD films are used. KORAD films are acrylic films commercially available from Spartech.

The present subject matter compositions are particularly well suited for use in forming photovoltaic backsheets. Photovoltaic (PV) backsheets protect photovoltaic modules from UV radiation, moisture and other environmental factors. The backsheets insulate the electrical aspects of the modules. Typically, PV modules are designed to pass qualification standards such as IEC 61215, IEC 61730, IEC 61646, and UL 1703.

In certain applications, such as in adhering a PV backsheet to an encapsulant, it is desirable that the backsheet exhibit good adhesion to an ethylene vinyl acetate (EVA) (a typical encapsulant), and particularly after exposure to damp heat, e.g. 85° C. and 85% RH for either 20 days or 40 days. Backsheets formed from the present subject matter compositions may exhibit EVA peel values (in accordance with ASTM D903) of at least 15 N/cm, particularly at least 40 N/cm, more particularly at least 60 N/cm, more particularly at least 80 N/cm, more particularly at least 100 N/cm, more particularly at least 120 N/cm, and in certain applications at least 140 N/cm and greater.

In certain applications, it may be desirable that a PV backsheet exhibit a relatively high percent elongation. This is desirable as low percentage elongations indicate brittleness of the backsheet. Backsheets formed from the present subject matter compositions may exhibit b* values less than 2.5, more particularly less than 2.0, more particularly less than 1.5, and in certain applications less than 1.0.

### EXAMPLES

Various tests and evaluations are described herein. Procedures for performing each of these are as follows.

Tensile testing was performed by in accordance with ASTM D882.

Tensile shock testing was performed in accordance with ASTM D882 Modified.

Elongation testing was performed in accordance with ASTM D882.

Elongation shock testing was performed in accordance with ASTM D882 Modified.

Strain at break shock testing was performed in accordance with ASTM D882.

60 Degree Gloss was measured using a Byk Gloss meter.

20 Degree Gloss was measured using a Byk Gloss meter.

Formed DOI was measured using a Byk Wavescan.

Formed Gloss was measured using a Byk Glossmeter.

Contrast Ratio was measured by using a Macbeth Color-Eye 7000 Colorimeter.

Blocking was measured in accordance with a modified ASTM D3354-11 method at 60° C. for 16 hours and 1.5 pounds per square inch.

Water immersion was evaluated by immersing samples in water for 14 days at 70° C. and then removing them and evaluating the samples for any blisters, staining, or other defects.

Viscosity was measured using a Brookfield Viscometer.

Carbon arc exposure was performed by a modified ASTM D6360-07 method.

Adhesive adhesion was measured by a T-peel testing procedure in accordance with ASTM D1876.

A series of evaluations were performed to assess aspects and characteristics of compositions in accordance with the present subject matter. A collection of film samples were prepared by varying proportions and types of components as follows.

Proportions (by weight) of components in the compositions were varied as set forth in Table 2:

TABLE 2
Varying Proportions of Components in Compositions

| Label | Factor Name | Level 1 | Level 2 | Level 3 |
|---|---|---|---|---|
| A | PVDF LEVEL | 75 | 70 | 65 |
| B | 2042/ACRYLIC RATIO | 10/90 | 20/80 | 30/70 |
| C | 2043/B-72 RATIO | 100/0 | 50/50 | 0/100 |
| D | BBP LEVEL | 3 | 5 | 7 |

In Table 2, “2042” refers to Elvacite 2042. “2043” refers to Elvacite 2043. “B-72” refers to B-72 ethyl methacrylate. “BBP” refers to butyl benzyl phthalate.

Using the proportions identified in Table 2, nine (9) trial compositions were prepared as summarized in Table 3:

TABLE 3
Summary of Trial Compositions

| TRIAL | A | B | C | D |
|---|---|---|---|---|
| 1 | 1 | 1 | 1 | 1 |
| 2 | 1 | 2 | 2 | 2 |
| 3 | 1 | 3 | 3 | 3 |
| 4 | 2 | 1 | 2 | 3 |
| 5 | 2 | 2 | 3 | 1 |
| 6 | 2 | 3 | 1 | 2 |
| 7 | 3 | 1 | 3 | 2 |
| 8 | 3 | 2 | 1 | 3 |
| 9 | 3 | 3 | 2 | 1 |

Specific amounts or levels of the various components in each of the trial compositions are set forth below in Table 4:

TABLE 4
Amounts of Components in Trial Compositions

| | | | PVDF | | | | DP- | | Solsperse |
|---|---|---|---|---|---|---|---|---|---|
| Trial | E-700 | BLO | 2824 | 2042 | 2043 | B-72 | 80107 | T-234 | 17000 |
| 1 | 75 | 25 | 75 | 2.5 | 22.5 | | 42 | 2 | 0.3 |
| 2 | 75 | 25 | 75 | 5 | 20 | | 42 | 2 | 0.3 |
| 3 | 75 | 25 | 75 | 7.5 | 17.5 | | 42 | 2 | 0.3 |
| 4 | 75 | 25 | 70 | 3 | 13.5 | 13.5 | 42 | 2 | 0.28 |
| 5 | 75 | 25 | 70 | 6 | 12 | 12 | 42 | 2 | 0.28 |
| 6 | 75 | 25 | 70 | 9 | 10.5 | 10.5 | 42 | 2 | 0.28 |
| 7 | 75 | 25 | 65 | 3.5 | | 31.5 | 42 | 2 | 0.26 |
| 8 | 75 | 25 | 65 | 7 | | 28 | 42 | 2 | 0.26 |
| 9 | 75 | 25 | 65 | 10.5 | | 24.5 | 42 | 2 | 0.26 |

In Table 4 above, “E-700” refers to Exxate 700, a high boiling ester solvent. “BLO” refers to n-butyrolactone. “2824” is Kynar 2824 resin. “D80107” is a white pigment dispersion. “T-234” is Tinuvin 234, a UV absorber. Solsperse 17000 is a previously noted dispersant. The other components are described herein.

Films were formed from the trial compositions and subjected to tensile testing after heat aging, elongation testing after heat aging, tensile testing after aging followed by heat aging, and elongation testing after aging and followed by aging. The results of these tests are presented in Tables 5-8 as follows.

TABLE 5
Tensile Testing After Heat Aging of 100 Hours at 80° C. (in PSI)

| Trial | Level 1 | Level 2 | Level 3 |
|---|---|---|---|
| 1 | 5,541.66 | 4,333.33 | 5,452.17 |
| 2 | 5,816.00 | 4,440.00 | 4,050.00 |
| 3 | 3,088.88 | 3,038.46 | 3,304.34 |
| 4 | 3,861.53 | 3,958.33 | 4,104.34 |
| 5 | 4,814.81 | 4,896.00 | 4,750.00 |
| 6 | 5,657.14 | 6,096.00 | 6,278.26 |
| 7 | 3,677.41 | 4,576.00 | 4,440.00 |
| 8 | 3,656.00 | 3,200.00 | 5,739.13 |
| 9 | 6,357.14 | 5,307.69 | 6,000.00 |

TABLE 6
Elongation Testing After Heat Aging of 100 Hours at 80° C.
(in % Elongation)

| Trial | Level 1 | Level 2 | Level 3 |
|---|---|---|---|
| 1 | 5.57 | 4.05 | 6.90 |
| 2 | 75.52 | 56.37 | 78.05 |
| 3 | 152.05 | 124.77 | 149.22 |
| 4 | 72.67 | 57.72 | 70.32 |
| 5 | 75.37 | 68.47 | 29.60 |
| 6 | 35.02 | 45.60 | 17.50 |
| 7 | 57.02 | 34.82 | 22.87 |
| 8 | 4.22 | 4.05 | 8.07 |
| 9 | 13.47 | 6.40 | 6.57 |

TABLE 7
Tensile Testing After Aging 48 Hours And After
Heat Aging of 100 Hours at 80° C. (in PSI)

| Trial | Level 1 | Level 2 | Level 3 |
|---|---|---|---|
| 1 | 2,316.66 | 4,480.00 | 3,484.61 |
| 2 | 4,485.71 | 4,592.85 | 4,744.82 |
| 3 | 3,761.90 | 3,552.38 | 3,478.26 |
| 4 | 4,358.33 | 4,304.34 | 3,721.73 |
| 5 | 5,125.00 | 4,330.43 | 4,691.66 |
| 6 | 1,982.60 | 5,304.34 | 4,808.69 |
| 7 | 4,653.84 | 4,269.23 | 4,192.30 |
| 8 | 4,852.17 | 2,791.66 | 4,913.04 |
| 9 | 4,634.78 | 5,000.00 | 2,373.91 |

TABLE 8
Elongation Testing After Aging 48 Hours and
After Heat Aging of 100 Hours at 80° C.
(In % Elongation)

| Trial | Level 1 | Level 2 | Level 3 |
|---|---|---|---|
| 1 | 5.52 | 4.20 | 5.55 |
| 2 | 19.95 | 15.10 | 76.32 |
| 3 | 51.75 | 37.40 | 75.37 |
| 4 | 52.27 | 9.57 | 6.75 |
| 5 | 16.07 | 5.37 | 26.70 |
| 6 | 4.05 | 4.05 | 5.55 |
| 7 | 53.77 | 83.57 | 39.12 |
| 8 | 6.55 | 5.57 | 6.92 |
| 9 | 5.20 | 5.70 | 5.22 |

The films were then scored by assigning a score of 1 to 5 with the higher number being considered better. Table 9 set forth below summarizes the scoring and total scores.

TABLE 9
Scoring of Films Formed From Trial Compositions

| | | PVDF | | | 2042/ | | | 2043/B-72 | | | BBP | |
|---|---|---|---|---|---|---|---|---|---|---|---|---|
| | | Level | | | acrylic ratio | | | ratio | | | level | |
| | 75 | 70 | 65 | 10/90 | 20/80 | 30/70 | 100/0 | 50/50 | 0/100 | 3 | 5 | 7 |
| Heat Aged | 1 | 3 | 2 | 1 | 2 | 3 | 5 | 3 | 1 | 5 | 3 | 1 |
| Tensile | | | | | | | | | | | | |
| Heat Aged | 5 | 3 | 1 | 1 | 2 | 3 | 1 | 3 | 5 | 1 | 2 | 3 |
| Elongations | | | | | | | | | | | | |
| Tensile 48 hours | 1 | 3 | 2 | 3 | 5 | 1 | 1 | 3 | 2 | 2 | 3 | 1 |
| after heat aging | | | | | | | | | | | | |
| Elongations 48 | 3 | 1 | 2 | 3 | 1 | 2 | 1 | 3 | 5 | 1 | 5 | 3 |
| hour after heat | | | | | | | | | | | | |
| aging | | | | | | | | | | | | |
| SUM | 10 | 10 | 7 | 8 | 10 | 9 | 8 | 12 | 13 | 9 | 13 | 8 |

From the results of this testing, several conclusions can be reached. Regarding Factor A, the PVDF levels of 75/25 and 70/30 were better than the 65/35 ratio. There was not much difference noted between the 75/25 and 70/30 ratios. Regarding Factor B, the 20/80 ratio of 2042/other acrylic resin ratio was slightly better than the 30/70 ratio which was slightly better than the 10/90 ratio. Concerning Factor C, the 0/100 ratio of 2043/B-72 was better than the 50/50 ratio, which was better than 100/0. And, regarding Factor D, the 5 parts of BBP was better than 3 parts, which was better than 7 parts.

Referring to Tables 6 and 8, it can also be seen that many of the present subject matter films after heat aging exhibited elongations of up to 5%, generally up to 10%, more particularly up to 25%, more particularly up to 50%, more particularly up to 75%, more particularly up to 100%, and in several instances up to 125% without breaking or fracturing. These elongations indicate that the films are flexible and significantly less prone to cracking or fracture as would otherwise occur with many conventional polyvinyl fluoride films known in the art.

In another set of evaluations, another collection of trial compositions were prepared. Eighteen (18) trial compositions were prepared as set forth below in Tables 10 and 11.

TABLE 10
Summary of Trial Compositions

| | | | | | | | | | | | | | | | % |
|---|---|---|---|---|---|---|---|---|---|---|---|---|---|---|---|
| | A- | A- | | | | | | | | | PLAS- | PLAS- | | | PIG- |
| | CRYL- | CRYL- | TO- | TO- | E-700 | BLO | E-700 | BLO | | SOL | TI- | TI- | | PVDF | MENT |
| TRI- | IC | IC | TAL | TAL | AT | AT | WITH | WITH | T- | SPERSE | CIZER | CIZER | PVDF | LE- | VOL |
| AL | TYPE | LEVEL | E-700 | BLO | START | START | HELD | HELD | 234 | 17000 | TYPE | LEVEL | TYPE | VEL | UME |
| 1 | 2043 | 20 | 75 | 25 | 35 | 11.667 | 40 | 13.333 | 1.5 | 0.32 | BBP | 0 | HTG | 80 | 8 |
| 2 | 2043 | 30 | 60 | 40 | 42 | 28 | 18 | 12 | 1.5 | 0.28 | DMP | 5 | HTG | 70 | 13 |
| 3 | 2043 | 40 | 45 | 55 | 42 | 51.333 | 3 | 3.666 | 1.5 | 0.24 | DBP | 10 | HTG | 60 | 18 |
| 4 | DOCK | 20 | 25 | 55 | 1 | 25.667 | 24 | 29.333 | 1.5 | 0.32 | BBP | 5 | HTG | 80 | 13 |
| 5 | DOCK | 30 | 45 | 25 | 22.5 | 17.5 | 22.5 | 7.5 | 1.5 | 0.28 | DMP | 10 | HTG | 70 | 18 |
| 6 | DOCK | 40 | 20 | 40 | 16 | 37.333 | 4 | 2.666 | 1.5 | 0.24 | DBP | 0 | HTG | 60 | 8 |
| 7 | B-72 | 20 | 60 | 40 | 28 | 18.667 | 32 | 21.333 | 1.5 | 0.32 | DMP | 0 | HTG | 80 | 18 |
| 8 | B-72 | 30 | 45 | 55 | 31.5 | 38.5 | 13.5 | 16.5 | 1.5 | 0.28 | DBP | 5 | HTG | 70 | 8 |
| 9 | B-72 | 40 | 75 | 25 | 70 | 23.333 | 5 | 1.666 | 1.5 | 0.24 | BBP | 10 | HTG | 60 | 13 |
| 10 | 2043 | 20 | 77.5 | 22.5 | 36.167 | 10.5 | 41.333 | 12 | 1.5 | 0.32 | DBP | 10 | 2824 | 80 | 13 |
| 11 | 2043 | 30 | 70 | 30 | 49 | 21 | 21 | 9 | 1.5 | 0.28 | BBP | 0 | 2824 | 70 | 18 |
| 12 | 2043 | 40 | 85 | 15 | 79.333 | 14 | 5.666 | 1 | 1.5 | 0.24 | DMP | 5 | 2824 | 60 | 8 |
| 13 | DOCK | 20 | 50 | 30 | 12.667 | 14 | 37.333 | 16 | 1.5 | 0.32 | DMP | 10 | 2824 | 80 | 8 |
| 14 | DOCK | 30 | 55 | 15 | 29.5 | 10.5 | 25.5 | 4.5 | 1.5 | 0.28 | DBP | 0 | 2824 | 70 | 13 |
| 15 | DOCK | 40 | 37.5 | 22.5 | 32.333 | 21 | 5.166 | 1.5 | 1.5 | 0.24 | BBP | 5 | 2824 | 60 | 18 |
| 16 | B-72 | 20 | 85 | 15 | 39.667 | 7 | 45.333 | 8 | 1.5 | 0.32 | DBP | 5 | 2824 | 80 | 18 |
| 17 | B-72 | 30 | 77.5 | 22.5 | 54.25 | 15.75 | 23.25 | 6.75 | 1.5 | 0.28 | BBP | 10 | 2824 | 70 | 8 |
| 18 | B-72 | 40 | 70 | 30 | 65.333 | 28 | 4.666 | 2 | 1.5 | 0.24 | DMP | 0 | 2824 | 60 | 13 |

TABLE 11
Summary of Trial Compositions

| | TOTAL | PIG- | | % | | | | | | | | |
|---|---|---|---|---|---|---|---|---|---|---|---|---|
| | VOL- | MENT | ACRYL- | ACRYL- | | | | | | | | ACRYL- |
| | UME | DISPER- | IC | IC IN | E-700 | BLO | E-700 | BLO | PIGMENT | | | IC |
| | WAN- | SION | RESIN | RESIN | AT | AT | WITH- | WITH- | TO | | | SOLU- |
| TRIAL | TED | AMOUNT | NEEDED | SYSTEM | START | START | HELD | HELD | BINDER | | TOTAL | TION |
| 1 | 8.213 | 41.247 | 20 | 24.804 | 35 | 11.667 | 40 | 13.333 | 1 | 5.575 | 243.07 | 66.666 |
| 2 | 9.153 | 74.695 | 24.214 | 33.828 | 33.901 | 22.601 | 26.099 | 17.399 | 1 | 3.061 | 275.69 | 80.716 |
| 3 | 10.207 | 115.336 | 22.134 | 40 | 23.241 | 28.406 | 21.758 | 26.594 | 1 | 1.874 | 309.21 | 73.781 |
| 4 | 8.685 | 70.880 | 9.020 | 20 | 0.451 | 11.577 | 24.548 | 43.423 | 1 | 3.049 | 246.72 | 21.048 |
| 5 | 9.711 | 109.731 | 30 | 40.169 | 22.5 | 17.5 | 22.5 | 7.5 | 1 | 2.304 | 291.51 | 70 |
| 6 | 9.098 | 45.688 | 36.461 | 42.050 | 14.585 | 34.031 | 5.415 | 5.969 | 1 | 4.898 | 203.89 | 85.076 |
| 7 | 9.119 | 103.03 | 4.039 | 20 | 5.654 | 3.769 | 54.345 | 36.230 | 1 | 2.097 | 288.9 | 13.463 |
| 8 | 8.527 | 42.822 | 30 | 34.354 | 31.5 | 38.5 | 13.5 | 16.5 | 1 | 5.382 | 249.6 | 100 |
| 9 | 9.439 | 77.032 | 34.033 | 43.378 | 59.559 | 19.853 | 15.440 | 5.146 | 1 | 2.973 | 282.81 | 113.446 |
| 10 | 8.685 | 70.880 | 20 | 27.914 | 36.167 | 10.5 | 41.333 | 12 | 1 | 3.384 | 282.7 | 66.666 |
| 11 | 9.711 | 109.731 | 21.501 | 35.483 | 35.119 | 15.051 | 34.881 | 14.949 | 1 | 2.137 | 303.01 | 71.671 |
| 12 | 9.098 | 45.688 | 32.922 | 40 | 65.297 | 11.523 | 19.703 | 3.477 | 1 | 4.731 | 245.35 | 109.742 |
| 13 | 8.213 | 41.247 | 16.805 | 22.476 | 10.643 | 11.764 | 39.356 | 18.236 | 1 | 5.408 | 229.87 | 39.212 |
| 14 | 9.153 | 74.695 | 18.429 | 30 | 18.122 | 6.450 | 36.877 | 8.549 | 1 | 2.894 | 234.91 | 43.002 |
| 15 | 10.207 | 115.336 | 40 | 49.094 | 32.333 | 21 | 5.166 | 1.5 | 1 | 2.209 | 282.08 | 93.333 |
| 16 | 9.119 | 103.039 | 12.019 | 25.912 | 23.839 | 4.2068 | 61.161195 | 10.793152 | 1 | 2.265345 | 301.88 | 40.065219 |
| 17 | 8.527 | 42.822 | 23.366 | 30 | 42.255 | 12.268 | 35.245 | 10.232 | 1 | 5.047 | 247.97 | 77.889 |
| 18 | 9.439 | 77.032 | 40 | 46.396 | 65.333 | 28 | 4.666 | 2 | 1 | 3.141 | 278.77 | 133.333 |

Films were formed from the compositions. The films were then subjected to various tests and evaluations. The films were scored by assigning a score of 1 to 7 with the higher number being considered better. Table 12 set forth below summarizes the scoring and total scores.

TABLE 12
Scoring of Films Formed from Trial Compositions

| | | | | | | | | | |
|---|---|---|---|---|---|---|---|---|---|
| Heat | Heat | | | | | | | Carb | |
| Aged | Aged | Formed | Formed | | Contrast | | Water | on | |
| Tensile | Elongations | DOI | Gloss | Viscosity | Ratio | Blocking | Immersion | Arc | Total |

| | | | | | | | | | | |
|---|---|---|---|---|---|---|---|---|---|---|
| PVDF TYPE | | | | | | | | | | |
| HTG | 1 | 1 | 1 | 1 | 1 | 3 | 2 | 3 | 1 | 14 |
| 2824 | 3 | 2 | 3 | 2 | 3 | 1 | 1 | 1 | 2 | 18 |
| ACRYLIC TYPE | | | | | | | | | | |
| 2043 | 1 | 1 | 2 | 1 | 3 | 1 | 5 | 1 | 1 | 16 |
| AC27-43 | 3 | 2 | 3 | 5 | 1 | 3 | 1 | 2 | 5 | 25 |
| B-72 | 5 | 5 | 1 | 3 | 2 | 2 | 3 | 3 | 3 | 27 |
| ACRYLIC LEVEL % | | | | | | | | | | |
| 20 | 5 | 2 | 2 | 1 | 1 | 1 | 7 | 3 | 5 | 27 |
| 30 | 2 | 5 | 1 | 3 | 3 | 3 | 4 | 1 | 3 | 25 |
| 40 | 1 | 1 | 5 | 5 | 5 | 2 | 1 | 1 | 1 | 22 |
| PLASTICIZER TYPE | | | | | | | | | | |
| BBP | 2 | 3 | 2 | 3 | 1 | 3 | 1 | 1 | 3 | 19 |
| DMP | 1 | 1 | 5 | 2 | 3 | 1 | 2 | 5 | 1 | 21 |
| DBP | 3 | 2 | 1 | 1 | 2 | 2 | 3 | 4 | 2 | 20 |
| PLASTICIZER | | | | | | | | | | |
| LEVEL % | | | | | | | | | | |
| 0 | 1 | 1 | 1 | 1 | 3 | 3 | 1 | 1 | 2 | 14 |
| 5 | 2 | 3 | 2 | 2 | 1 | 5 | 2 | 2 | 1 | 20 |
| 10 | 3 | 5 | 3 | 3 | 5 | 1 | 3 | 2 | 3 | 28 |
| % PIGMENT PVC | | | | | | | | | | |
| 8 | 3 | 5 | 5 | 5 | 1 | 1 | 5 | 5 | 5 | 35 |
| 13 | 5 | 2 | 3 | 3 | 2 | 4 | 3 | 3 | 3 | 28 |
| 18 | 1 | 1 | 1 | 1 | 3 | 7 | 1 | 1 | 1 | 17 |
| SOLVENT SYSTEM | | | | | | | | | | |
| 75/25-85/15 | 3 | 1 | 1 | 1 | 5 | 3 | 1 | 5 | 1 | 21 |
| 60/40-77.5/22.5 | 1 | 3 | 2 | 3 | 3 | 1 | 2 | 1 | 2 | 18 |
| 45/55-70/30 | 5 | 1 | 3 | 2 | 1 | 2 | 3 | 2 | 3 | 22 |
| % ACRYLIC | | | | | | | | | | |
| REPLACED | | | | | | | | | | |
| 0 | 1 | 2 | 3 | 3 | 2 | 1 | 2 | 1 | 1 | 16 |
| 50 | 3 | 1 | 2 | 2 | 3 | 3 | 1 | 3 | 5 | 23 |
| 100 | 2 | 3 | 1 | 1 | 1 | 2 | 5 | 5 | 3 | 23 |

Tables 13 and 14 include data of various measurements and evaluations from the trials.

TABLE 13
Data and Testing Results of Films Formed from Trial Compositions

| Trial # | 1 | 2 | 3 | 4 | 5 | 6 | 7 | 8 | 9 |
|---|---|---|---|---|---|---|---|---|---|
| Tensile | 5.1 | 4.67 | 0.87 | 5.32 | 0.8 | 1.57 | 1.8 | 4.3 | 3.02 |
| (in pounds) | 5.72 | 4.62 | 1.15 | 5.47 | 2.17 | 1.2 | 0.82 | 4.9 | 2.85 |
| | 4.05 | 4.6 | 2.62 | 5.15 | 1.72 | 0.6 | 1.15 | 4.92 | 2.8 |
| Tensile Average | 4.956667 | 4.63 | 1.546667 | 5.313333 | 1.563333 | 1.123333 | 1.256667 | 4.706667 | 2.89 |
| Thickness | 1.25 | 1.2 | 1.05 | 1.25 | 1.4 | 1.5 | 0.95 | 1.3 | 1.25 |
| (in mils) | 1.25 | 1.2 | 1.05 | 1.3 | 1.35 | 1.5 | 0.95 | 1.3 | 1.25 |
| | 1.4 | 1.2 | 1.05 | 1.45 | 1.4 | 1.5 | 0.95 | 1.3 | 1.25 |
| Thickness Average | 1.3 | 1.2 | 1.05 | 1.333333 | 1.383333 | 1.5 | 0.95 | 1.3 | 1.25 |
| Tensile | 4080 | 3891.667 | 828.5714 | 4256 | 571.4286 | 1046.667 | 1894.737 | 3307.692 | 2416 |
| (in PSI) | 4576 | 3850 | 1095.238 | 4207.692 | 1607.407 | 800 | 863.1579 | 3769.231 | 2280 |
| | 2892.857 | 3833.333 | 2495.238 | 3551.724 | 1228.571 | 400 | 1210.526 | 3784.615 | 2240 |
| Tensile Average | 3812.821 | 3858.333 | 1473.016 | 3985 | 1130.12 | 748.8889 | 1322.807 | 3620.513 | 2312 |
| Coat Weight (GSM) | 49 | 49 | 41 | 59 | 57 | 53 | 41 | 52 | 49 |
| Elongation | 5.72 | 5.4 | 2.7 | 37.62 | 1.35 | 2.85 | 4.22 | 1122.57 | 118.6 |
| | 6.72 | 5.05 | 3.2 | 39.17 | 3.2 | 4.05 | 5.72 | 177.9 | 61.95 |
| | 3.95 | 5.4 | 5.72 | 35.12 | 4.4 | 2.52 | 4.05 | 187.9 | 105.5 |
| Elongation Average | 5.463333 | 5.283333 | 3.873333 | 37.30333 | 2.983333 | 3.14 | 4.663333 | 496.1233 | 95.35 |
| Heat Aged Tensile | 1.4 | 0.18 | 0.2 | 6.08 | 0.2 | 0.78 | 1.1 | 4.9 | 5.5 |
| (in pounds) | 3.5 | 0.7 | 1.23 | 6.1 | 0.5 | 1.58 | 0.55 | 4.6 | 5.78 |
| | 2.4 | 0.33 | 1.95 | 6.1 | 1.83 | 0.25 | 1.28 | 4.95 | 5.23 |
| Trial # | 1 | 2 | 3 | 4 | 5 | 6 | 7 | 8 | 9 |
| Trial # | 10 | 11 | 12 | 13 | 14 | 15 | 16 | 17 | 18 |
| Tensile | 2.77 | 3.52 | 2.88 | 3.53 | 3.85 | 3.25 | 3.55 | 3.9 | 4.58 |
| (in pounds) | 2.87 | 3.32 | 3.18 | 3.25 | 4.03 | 3.15 | 3.45 | 3.73 | 4.00 |
| | 2.97 | 3.8 | 3.3 | 3.58 | 4.18 | 3.23 | 3.83 | 2.2 | 4.25 |
| Tensile Average | 2.87 | 3.546667 | 3.12 | 3.453333 | 4.02 | 3.21 | 3.61 | 3.276667 | 4.27 |
| Thickness | 1 | 1.1 | 1.15 | 0.95 | 1.15 | 1.3 | 1.2 | 1.3 | 1.40 |
| (in mils) | 0.95 | 1.1 | 1.1 | 1 | 1.3 | 1.2 | 1.15 | 1.2 | 1.35 |
| | 1.05 | 1.1 | 1.1 | 0.95 | 1.3 | 1.2 | 1.25 | 1 | 1.30 |
| Thickness Average | 1 | 1.1 | 1.116667 | 0.966667 | 1.25 | 1.233333 | 1.2 | 1.166667 | 1.35 |
| Tensile | 2770 | 3200 | 2504.348 | 3715.789 | 3347.826 | 2500 | 2958.333 | 3000 | 3271.42 |
| (in PSI) | 3021.053 | 3018.182 | 2890.909 | 3250 | 3100 | 2625 | 3000 | 3108.333 | 2962.96 |
| | 2828.571 | 3454.545 | 3000 | 3768.421 | 3215.385 | 2691.667 | 3064 | 2200 | 3269.23 |
| Tensile Average | 2870 | 3224.242 | 2794.03 | 3572.414 | 3216 | 2602.703 | 3008.333 | 2808.571 | 3167.90 |
| Coat Weight (GSM) | 42 | 50 | 44 | 44 | 54 | 52 | 57 | 45 | 53.00 |
| Elongation | 93.17 | 107.9 | 138 | 348 | 178 | 193 | 90 | 431 | 2.70 |
| | 127.92 | 109.42 | 184 | 363 | 238 | 203 | 53.5 | 428 | 2.40 |
| | 64 | 104.97 | 172 | 374 | 137 | 187 | 75.7 | 303 | 2.73 |
| Elongation Average | 95.03 | 107.43 | 164.6667 | 361.6667 | 184.3333 | 194.3333 | 73.06667 | 387.3333 | 2.61 |
| Heat Aged Tensile | 2.62 | 0.7 | 0.52 | 5.02 | 6.3 | 0.75 | 5.45 | 2.45 | 4.85 |
| (in pounds) | 1.62 | 1.13 | 2.2 | 5.75 | 5.32 | 0.5 | 5.9 | 2.4 | 5.35 |
| | 3.07 | 1 | 0.32 | 5.97 | 5.85 | 0.45 | 5.55 | 2.4 | 7.10 |
| Trial # | 10 | 11 | 12 | 13 | 14 | 15 | 16 | 17 | 1.80 |

TABLE 14
Data and Testing Results of Films Formed from Trial Compositions

| Trial # | 1 | 2 | 3 | 4 | 5 | 6 | 7 | 8 | 9 |
|---|---|---|---|---|---|---|---|---|---|
| Aver- | 2.433333 | 0.403333 | 1.126667 | 6.093333 | 0.843333 | 0.87 | 0.976667 | 4.816667 | 5.503333 |
| age | | | | | | | | | |
| Heat | | | | | | | | | |
| Aged | | | | | | | | | |
| Ten- | | | | | | | | | |
| sile | | | | | | | | | |
| Heat | 1120 | 150 | 190.4762 | 4864 | 142.8571 | 520 | 1157.895 | 3769.231 | 4400 |
| Aged | | | | | | | | | |
| Ten- | | | | | | | | | |
| sile | | | | | | | | | |
| (in | 2800 | 583.3333 | 1171.429 | 4692.308 | 370.3704 | 1053.333 | 578.9474 | 3538.462 | 4624 |
| PSI) | | | | | | | | | |
| | 1714.286 | 275 | 1857.143 | 4206.897 | 1307.143 | 166.6667 | 1347.368 | 3807.692 | 4184 |
| Aver- | 1871.795 | 336.1111 | 1073.016 | 4570 | 609.6386 | 580 | 1028.07 | 3705.128 | 4402.667 |
| age | | | | | | | | | |
| Heat | | | | | | | | | |
| Aged | | | | | | | | | |
| Ten- | | | | | | | | | |
| sile | | | | | | | | | |
| Heat | 1.35 | 1.17 | 3.2 | 29.77 | 1.85 | 4.05 | 3.22 | 109.05 | 5.07 |
| Aged | | | | | | | | | |
| Elon- | | | | | | | | | |
| gation | | | | | | | | | |
| | 3.7 | 1.2 | 4.55 | 37.72 | 2.37 | 4.05 | 2.7 | 121.17 | 5.4 |
| | 2.5 | 1.1 | 2.52 | 17.32 | 5.05 | 1.37 | 1.35 | 68.67 | 2.7 |
| Aver- | 2.516667 | 1.156667 | 3.423333 | 28.27 | 3.09 | 3.156667 | 2.423333 | 99.63 | 4.39 |
| age | | | | | | | | | |
| Heat | | | | | | | | | |
| Aged | | | | | | | | | |
| Elon- | | | | | | | | | |
| gation | | | | | | | | | |
| Air | 16 | 21 | 23 | 33 | 18 | 17 | 20 | 29 | 10 |
| Side | | | | | | | | | |
| DOI | | | | | | | | | |
| 0 inch | 34 | 34 | 34 | 29 | 34 | 37 | 29 | 36 | 34 |
| formed | | | | | | | | | |
| DOI | | | | | | | | | |
| 1 inch | 36 | 34 | 30 | 30 | 35 | 37 | 30 | 37 | 31 |
| formed | | | | | | | | | |
| DOI | | | | | | | | | |
| 2 inch | 35 | 34 | 28 | 29 | 32 | 37 | 25 | 36 | 31 |
| formed | | | | | | | | | |
| DOI | | | | | | | | | |
| Air | 5 | 14 | 7 | 35 | 10 | 9 | 1 | 31 | 2 |
| Side | | | | | | | | | |
| Gloss | | | | | | | | | |
| 0 inch | 39 | 37 | 35 | 36 | 44 | 52 | 28 | 44 | 45 |
| formed | | | | | | | | | |
| gloss | | | | | | | | | |
| 1 inch | 35 | 26 | 8 | 27 | 21 | 45 | 15 | 43 | 34 |
| formed | | | | | | | | | |
| gloss | | | | | | | | | |
| 2 inch | 35 | 22 | 7 | 21 | 18 | 46 | 4 | 40 | 31 |
| formed | | | | | | | | | |
| gloss | | | | | | | | | |
| Visco- | 12800 | 6480 | 3280 | 38800 | 4800 | 12600 | 11400 | 28800 | 4320 |
| sity | | | | | | | | | |
| (cps) | | | | | | | | | |
| Hot | 1.38 | 1.23 | 0.88 | 1.5 | 0.98 | 0.71 | 1.55 | 0.9 | 0.82 |
| Ten- | | | | | | | | | |
| sile | | | | | | | | | |
| in | | | | | | | | | |
| pounds | | | | | | | | | |
| Hot | 1.061538 | 1.025 | 0.838095 | 1.125 | 0.708434 | 0.473333 | 1.631579 | 0.692308 | 0.656 |
| Ten- | | | | | | | | | |
| sile | | | | | | | | | |
| in PSI | | | | | | | | | |
| Hot | 36 | 75 | 47 | 90 | 45 | 51 | 19 | 102 | 66 |
| Elon- | | | | | | | | | |
| gation | | | | | | | | | |
| Hot | 0.038333 | 0.0164 | 0.018723 | 0.016667 | 0.021778 | 0.013922 | 0.081579 | 0.008824 | 0.012424 |
| Ten- | | | | | | | | | |
| sile/ | | | | | | | | | |
| Hot | | | | | | | | | |
| Elon- | | | | | | | | | |
| gation | | | | | | | | | |
| Hot | 0.47 | 0.37 | 0.4 | 0.79 | 0.4 | 0.44 | 0.01 | 0.47 | 0.22 |
| Ten- | | | | | | | | | |
| sile | | | | | | | | | |
| in | | | | | | | | | |
| pounds | | | | | | | | | |
| @ 16% | | | | | | | | | |
| elong | | | | | | | | | |
| Hot | 361.5385 | 308.3333 | 380.9524 | 592.5 | 289.1566 | 293.3333 | 10.52632 | 361.5385 | 176 |
| Ten- | | | | | | | | | |
| sile | | | | | | | | | |
| in PSI | | | | | | | | | |
| @ 16% | | | | | | | | | |
| elon- | | | | | | | | | |
| gation | | | | | | | | | |
| Trial # | 10 | 11 | 12 | 13 | 14 | 15 | 16 | 17 | 18 |
| Aver- | 2.436667 | 0.943333 | 1.013333 | 5.58 | 5.823333 | 0.566667 | 5.633333 | 2.416667 | 5.766667 |
| age | | | | | | | | | |
| Heat | | | | | | | | | |
| Aged | | | | | | | | | |
| Ten- | | | | | | | | | |
| sile | | | | | | | | | |
| Heat | 2620 | 636.3636 | 452.1739 | 5284.211 | 5478.261 | 576.9231 | 4541.667 | 1884.615 | 3464.286 |
| Aged | | | | | | | | | |
| Ten- | | | | | | | | | |
| sile | | | | | | | | | |
| (in | 1705.263 | 1027.273 | 2000 | 5750 | 4092.308 | 416.6667 | 5130.435 | 2000 | 3962.963 |
| PSI) | | | | | | | | | |
| | 2923.81 | 909.0909 | 290.9091 | 6284.211 | 4500 | 375 | 4440 | 2400 | 5461.538 |
| Aver- | 2436.667 | 857.5758 | 907.4627 | 5772.414 | 4658.667 | 459.4595 | 4694.444 | 2071.429 | 4271.605 |
| age | | | | | | | | | |
| Heat | | | | | | | | | |
| Aged | | | | | | | | | |
| Ten- | | | | | | | | | |
| sile | | | | | | | | | |
| Heat | 2.5 | 1.17 | 1.32 | 8.02 | 4.17 | 4.05 | 17.37 | 144 | 5.2 |
| Aged | | | | | | | | | |
| Elon- | | | | | | | | | |
| gation | | | | | | | | | |
| | 2 | 1.354 | 2.5 | 66.77 | 3.85 | 1.32 | 13.2 | 373.77 | 5.85 |
| | 5.17 | 2.67 | 1.32 | 21.57 | 4.2 | 2.87 | 14.87 | 270.27 | 5.2 |
| Aver- | 3.223333 | 1.731333 | 1.713333 | 32.12 | 4.073333 | 2.746667 | 15.14667 | 262.68 | 5.41 |
| age | | | | | | | | | |
| Heat | | | | | | | | | |
| Aged | | | | | | | | | |
| Elon- | | | | | | | | | |
| gation | | | | | | | | | |
| Air | 21 | 17 | 47 | 34 | 26 | 36 | 21 | 22 | 38 |
| Side | | | | | | | | | |
| DOI | | | | | | | | | |
| 0 inch | 41 | 35 | 58 | 43 | 33 | 55 | 34 | 32 | 62 |
| formed | | | | | | | | | |
| DOI | | | | | | | | | |
| 1 inch | 34 | 30 | 35 | 67 | 34 | 36 | 30 | 40 | 34 |
| formed | | | | | | | | | |
| DOI | | | | | | | | | |
| 2 inch | 30 | 22 | 35 | 39 | 30 | 35 | 25 | 34 | 34 |
| formed | | | | | | | | | |
| DOI | | | | | | | | | |
| Air | 23 | 2 | 53 | 30 | 27 | 54 | 9 | 23 | 54 |
| Side | | | | | | | | | |
| Gloss | | | | | | | | | |
| 0 inch | 37 | 33 | 50 | 56 | 39 | 52 | 35 | 46 | 48 |
| formed | | | | | | | | | |
| gloss | | | | | | | | | |
| 1 inch | 27 | 12 | 31 | 53 | 24 | 35 | 11 | 43 | 21 |
| formed | | | | | | | | | |
| gloss | | | | | | | | | |
| 2 inch | 15 | 2 | 30 | 43 | 17 | 26 | 3 | 38 | 18 |
| formed | | | | | | | | | |
| gloss | | | | | | | | | |
| Visco- | 560 | 760 | 140 | 900 | 1040 | 1420 | 480 | 540 | 2650 |
| sity | | | | | | | | | |
| (cps) | | | | | | | | | |
| Hot | 1.36 | 1.35 | 0.8 | 2.04 | 1.56 | 0.65 | 1.7 | 1.38 | 1.14 |
| Ten- | | | | | | | | | |
| sile | | | | | | | | | |
| in | | | | | | | | | |
| pounds | | | | | | | | | |
| Hot | 1.36 | 1.227273 | 0.716418 | 2.110345 | 1.248 | 0.527027 | 1.416667 | 1.182857 | 0.844444 |
| Ten- | | | | | | | | | |
| sile | | | | | | | | | |
| in PSI | | | | | | | | | |
| Hot | 223 | 218 | 207 | 298 | 209 | 125 | 239 | 270 | 170 |
| Elon- | | | | | | | | | |
| gation | | | | | | | | | |
| Hot | 0.006099 | 0.006193 | 0.003865 | 0.006846 | 0.007464 | 0.0052 | 0.007113 | 0.005111 | 0.006706 |
| Tensile/ | | | | | | | | | |
| Hot | | | | | | | | | |
| Elon- | | | | | | | | | |
| gation | | | | | | | | | |
| Hot | 0.01 | 0.52 | 0.12 | 0.17 | 0.12 | 0.02 | 0.25 | 0.2 | 0.1 |
| Ten- | | | | | | | | | |
| sile | | | | | | | | | |
| in | | | | | | | | | |
| pounds | | | | | | | | | |
| @ 16% | | | | | | | | | |
| elong | | | | | | | | | |
| Hot | 10 | 472.7273 | 107.4627 | 175.8621 | 96 | 16.21622 | 208.3333 | 171.4286 | 74.07407 |
| Ten- | | | | | | | | | |
| sile | | | | | | | | | |
| in PSI | | | | | | | | | |
| @ 16% | | | | | | | | | |
| elon- | | | | | | | | | |
| gation | | | | | | | | | |

Films formed from the subject matter compositions exhibited a unique combination of properties such as shown in Tables 13 and 14. For example, the films exhibited tensile values of from 1.12 pounds to 5.31 pounds (748.89 psi to 2985 psi); elongation values of from 2.98% to 496.12%; heat aged tensile values of from 0.40 pounds to 6.09 pounds (226 psi to 4570 psi); heat aged elongation values of from 1.15% to 262.68%; and hot tensile at 16% elongation values of from 0.01 pounds to 0.79 pounds (10.53 psi to 592.5 psi).

In this series of evaluations and as generally illustrated in Table 12 the following conclusions can be reached. The PVDF copolymer 2824 was slightly better than the PVDF hompolymer HTG. As for type of acrylic component, the B-72 component was better than the 2043 and AC27-43 components. An acrylic proportion of 20% was slightly better than the 30% level which was much better than the 40% level. As for the type of plasticizer, there was no significant difference between BBP, DMP, and DBP. However, use of 10% plasticizer was significantly better than a 5% level, which was better than no plasticizer. As for the level of pigment, 8% was better than 13% which was better than 18%. There was no major difference with regard to the solvent system used. And, it is generally preferred to replace at least a portion of the acrylic component.

Another series of evaluations was performed to assess aspects and characteristics of compositions in accordance with the present subject matter. A collection of film samples were prepared by varying proportions and types of components as follows.

Proportions (by weight) of components in the compositions were varies as set forth in Table 15:

TABLE 15
Varying Proportions of Components in Composition

| Label | Factor Name | Level 1 | Level 2 | Level 3 |
|---|---|---|---|---|
| A | PVDF Type | RF500 | RF7202 | |
| B | Acrylic Type | 2899 | 2008 | B72 |
| C | Acrylic Level | 25 | 30 | 35 |
| D | Plasticizer | Edenol | Paraplex | Santicizer |
| | Type | 9790 | A-8210 | Platinum P1400 |
| E | Plasticizer | 0 | 10 | 20 |
| | Level | | | |
| F | Pigment Level | 0 | 0.5 | 1 |
| G | Size Type | RA68040 | RA2899 | RA2614 |
| H | Size Level | 100HK | 150HK | 200HK |

In Table 15, “RF500” refers to Kynar 500 plus PVDF from Arkema. “RF7202” is Kynar 7201F PVDF from Arkema. “2899” is Elvacite 2899. “2008” is Elvacite 2008. “B-72” is B-72 acrylic resin from Rohm and Haas. The materials noted for size type are solution acrylic TEDLAR adhesives available from DuPont. The references to size level are industry recognized designations for gravure cylinder patterns used for applying the noted adhesives.

Using the proportions identified in Table 15, eighteen (18) trial compositions were prepared as summarized in Table 16:

TABLE 16
Summary of Trial Compositions

| Trial | A | B | C | D | E | F | G | H |
|---|---|---|---|---|---|---|---|---|
| 1 | 1 | 1 | 1 | 1 | 1 | 1 | 1 | 1 |
| 2 | 1 | 1 | 2 | 2 | 2 | 2 | 2 | 2 |
| 3 | 1 | 1 | 3 | 3 | 3 | 3 | 3 | 3 |
| 4 | 1 | 2 | 1 | 1 | 2 | 2 | 3 | 3 |
| 5 | 1 | 2 | 2 | 2 | 3 | 3 | 1 | 1 |
| 6 | 1 | 2 | 3 | 3 | 1 | 1 | 2 | 2 |
| 7 | 1 | 3 | 1 | 2 | 1 | 3 | 2 | 3 |
| 8 | 1 | 3 | 2 | 3 | 2 | 1 | 3 | 1 |
| 9 | 1 | 3 | 3 | 1 | 3 | 2 | 1 | 2 |
| 10 | 2 | 1 | 1 | 3 | 3 | 2 | 2 | 1 |
| 11 | 2 | 1 | 2 | 1 | 1 | 3 | 3 | 2 |
| 12 | 2 | 1 | 3 | 2 | 2 | 1 | 1 | 3 |
| 13 | 2 | 2 | 1 | 2 | 3 | 1 | 3 | 2 |
| 14 | 2 | 2 | 2 | 3 | 1 | 2 | 1 | 3 |
| 15 | 2 | 2 | 3 | 1 | 2 | 3 | 2 | 1 |
| 16 | 2 | 3 | 1 | 3 | 2 | 3 | 1 | 2 |
| 17 | 2 | 3 | 2 | 1 | 3 | 1 | 2 | 3 |
| 18 | 2 | 3 | 3 | 2 | 1 | 2 | 3 | 1 |

Specific amounts or levels, i.e. parts by weight, of the various components in each of the trial compositions are set forth below in Table 17:

TABLE 17
Amounts of Components in Trial Compositions

| | | | | | | Santicizer | | | | | | | | |
|---|---|---|---|---|---|---|---|---|---|---|---|---|---|---|
| | | | | Edenol | Paraplex | Platinum | | | | Pentyl | | | | |
| Trial | 2899 | 2008 | B-72 | 9790 | A-8210 | P1400 | MPK | CYC | DIBK | Propionate | BLO | RF330 | RF7202 | DP80107 |
| 1 | 25 | | | 5 | | | | 60 | 15 | 30 | 45 | 75 | | |
| 2 | 30 | | | | 10 | | | 60 | 15 | 30 | 45 | 70 | | 50 |
| 3 | 35 | | | | | 20 | | 60 | 15 | 30 | 45 | 65 | | 100 |
| 4 | | 25 | | 10 | | | | 60 | 15 | 30 | 45 | 75 | | 50 |
| 5 | | 30 | | | 20 | | | 60 | 15 | 30 | 45 | 70 | | 100 |
| 6 | | 35 | | | | 5 | | 60 | 15 | 30 | 45 | 65 | | |
| 7 | | | 25 | | 5 | | | 60 | 15 | 30 | 45 | 75 | | 100 |
| 8 | | | 30 | | | 10 | | 60 | 15 | 30 | 45 | 70 | | |
| 9 | | | 35 | 20 | | | | 60 | 15 | 30 | 45 | 65 | | 50 |
| 10 | 25 | | | | | 20 | 135 | 135 | | | | | 75 | 50 |
| 11 | 30 | | | 5 | | | 135 | 135 | | | | | 70 | 100 |
| 12 | 35 | | | | 10 | | 135 | 135 | | | | | 65 | |
| 13 | 25 | 20 | | | 20 | | 135 | 135 | | | | | 75 | |
| 14 | | 30 | | | | 5 | 135 | 135 | | | | | 70 | 50 |
| 15 | | 35 | | 10 | | | 135 | 135 | | | | | 65 | 100 |
| 16 | | | 25 | | | 10 | 135 | 135 | | | | | 75 | 100 |
| 17 | | | 30 | 20 | | | 135 | 135 | | | | | 70 | |
| 18 | | | 35 | | 5 | | 135 | 135 | | | | | 65 | 50 |

In Table 17 above, “2899”, “2008”, and “B-72” are acrylic components as previously described herein. Edenol 9790, Paraplex A-8210, and Santicizer Platinum P1400 are plasticizers as previously described herein. “MPK”, “CYC” and “DIBK” are solvents as previously described herein. “BLO” is n-butyrolactone, a solvent, as previously noted, “RF330” and “RF7202” are PVDF resins, as noted. And “DP80107” is a white pigment dispersion.

Films were formed from the trial compositions and then subjected to various testing and evaluations: blocking, opacity, tensile testing, elongation testing, 60 degree gloss testing, 20 degree gloss testing, blue ink adhesion, and adhesive adhesion. The results of these tests are presented in Tables 18-25. Generally, laminated assemblies for testing were prepared by coating the present subject matter compositions onto 2 mil PET to a dry thickness of about 1.8 mils. For other testing, the composition was printed using particular gravure cylinder patterns onto a sheet. The tensile and elongation values of the films were measured in removal from the PET. For certain measurements, the laminates were subjected to heat aging at 140° F. for one week and then tensile and elongation measurements were made in removing the film from the PET. For blue ink adhesion testing, a blue ink was coated onto the films without size coating, using a Meyer rod. Using a commercially available adhesive from Boeing, the blue ink side was laminated to the PET face of the laminated assembly of film/PET. The lamination was repeated with the Boeing adhesive of the blue ink side to a layer of a sized coating of the present subject matter. T-peel measurement techniques are then used.

TABLE 18
Blocking at 60° C. for 16 Hours

| | Blocking @ 60 C. for 16 Hrs |
|---|---|
| Trial | BB Rating (Higher is Better) |
| 1 | 7.00 |
| 2 | 7.00 |
| 3 | 5.00 |
| 4 | 7.00 |
| 5 | 7.00 |
| 6 | 7.00 |
| 7 | 6.00 |
| 8 | 3.00 |
| 9 | 4.00 |
| 10 | 1.00 |
| 11 | 1.00 |
| 12 | 1.00 |
| 13 | 1.00 |
| 14 | 1.00 |
| 15 | 1.00 |
| 16 | 1.00 |
| 17 | 2.00 |
| 18 | 1.00 |

TABLE 19
Opacity

| | Opacity |
|---|---|
| Trial | (Higher is Better) |
| 1 | 17.51 |
| 2 | 92.78 |
| 3 | 95.26 |
| 4 | 94.58 |
| 5 | 94.82 |
| 6 | 17.66 |
| 7 | 96.84 |
| 8 | 17.66 |
| 9 | 94.33 |
| 10 | 94.17 |
| 11 | 97.89 |
| 12 | 15.30 |
| 13 | 15.90 |
| 14 | 94.20 |
| 15 | 97.60 |
| 16 | 94.76 |
| 17 | 17.32 |
| 18 | 97.88 |

TABLE 20
Tensile Testing (in PSI)

| | |
|---|---|
| | Tensile in PSI |
| Trial | (Higher is Better) |

| | | |
|---|---|---|
| 1 | 1,112.00 | 2,075.00 |
| 2 | 1.00 | 1.00 |
| 3 | 1.00 | 1.00 |
| 4 | 1,935.00 | 237.00 |
| 5 | 1.00 | 1.00 |
| 6 | 378.00 | 24.00 |
| 7 | 1,534.00 | 1,534.00 |
| 8 | 1,671.00 | 1,421.00 |
| 9 | 294.00 | 62.00 |
| 10 | 908.00 | 872.00 |
| 11 | 927.00 | 1,115.00 |
| 12 | 1,343.00 | 1,120.00 |
| 13 | 1,065.00 | 901.00 |
| 14 | 1,598.00 | 1,096.00 |
| 15 | 846.00 | 1,061.00 |
| 16 | 1,348.00 | 1,329.00 |
| 17 | 715.00 | 579.00 |
| 18 | 842.00 | 972.00 |

TABLE 21
Elongation

| | |
|---|---|
| | Elongation |
| Trial | (Nominal is Best) |

| | | |
|---|---|---|
| 1 | 1.50 | 1.80 |
| 2 | 0.10 | 0.10 |
| 3 | 0.10 | 0.10 |
| 4 | 1.30 | 0.20 |
| 5 | 0.10 | 0.10 |
| 6 | 0.40 | 0.30 |
| 7 | 1.20 | 1.20 |
| 8 | 28.30 | 25.20 |
| 9 | 1.00 | 0.30 |
| 10 | 491.00 | 296.00 |
| 11 | 99.10 | 108.50 |
| 12 | 298.00 | 187.00 |
| 13 | 335.00 | 198.00 |
| 14 | 267.00 | 217.00 |
| 15 | 99.70 | 99.30 |
| 16 | 291.00 | 284.00 |
| 17 | 372.00 | 301.00 |
| 18 | 297.00 | 250.00 |

TABLE 22
60 Degree Gloss

| | |
|---|---|
| Trial | 60 Degree Gloss |

| | | |
|---|---|---|
| 1 | 26.00 | 74.20 |
| 2 | 13.70 | 24.90 |
| 3 | 8.10 | 27.60 |
| 4 | 14.60 | 35.90 |
| 5 | 13.20 | 37.20 |
| 6 | 18.40 | 42.90 |
| 7 | 18.00 | 46.50 |
| 8 | 32.00 | 90.00 |
| 9 | 10.30 | 45.80 |
| 10 | 56.00 | 84.00 |
| 11 | 75.00 | 83.80 |
| 12 | 95.00 | 95.00 |
| 13 | 90.00 | 99.00 |
| 14 | 78.10 | 74.30 |
| 15 | 78.80 | 77.00 |
| 16 | 76.70 | 87.20 |
| 17 | 99.00 | 62.50 |
| 18 | 74.20 | 66.80 |

TABLE 23
20 Degree Gloss

| | |
|---|---|
| Trial | 20 Degree Gloss |

| | | |
|---|---|---|
| 1 | 18.60 | 36.70 |
| 2 | 1.70 | 4.00 |
| 3 | 1.60 | 4.90 |
| 4 | 1.80 | 6.10 |
| 5 | 1.90 | 6.60 |
| 6 | 10.20 | 19.30 |
| 7 | 1.90 | 10.60 |
| 8 | 30.80 | 70.80 |
| 9 | 1.50 | 12.10 |
| 10 | 15.20 | 55.80 |
| 11 | 46.20 | 69.20 |
| 12 | 91.00 | 63.20 |
| 13 | 95.00 | 90.00 |
| 14 | 59.70 | 38.20 |
| 15 | 60.60 | 39.40 |
| 16 | 56.70 | 51.80 |
| 17 | 99.00 | 29.10 |
| 18 | 51.60 | 36.50 |

TABLE 24
Blue Ink Adhesion (in N/inch width)

| | |
|---|---|
| | Blue Ink Adhesion |
| Trial | (Higher is Better) |

| | | |
|---|---|---|
| 1 | 1.20 | 1.80 |
| 2 | 1.17 | 0.31 |
| 3 | 0.10 | 0.10 |
| 4 | 9.17 | 4.60 |
| 5 | 0.10 | 0.10 |
| 6 | 0.25 | 0.25 |
| 7 | 2.50 | 4.38 |
| 8 | 5.69 | 5.69 |
| 9 | 4.40 | 4.38 |
| 10 | 7.20 | 7.00 |
| 11 | 7.40 | 6.55 |
| 12 | 10.10 | 12.40 |
| 13 | 10.50 | 10.50 |
| 14 | 9.56 | 10.41 |
| 15 | 7.15 | 5.16 |
| 16 | 9.33 | 10.59 |
| 17 | 8.00 | 7.16 |
| 18 | 8.50 | 8.50 |

TABLE 25
Adhesive Adhesion (in N/inch width)

| | |
|---|---|
| | Adhesive Adhesion |
| Trial | (Higher is Better) |

| | | |
|---|---|---|
| 1 | 2.16 | 0.30 |
| 2 | 2.33 | 0.30 |
| 3 | 0.42 | 0.27 |
| 4 | 1.59 | 2.52 |
| 5 | 0.07 | 0.07 |
| 6 | 0.81 | 3.75 |
| 7 | 2.70 | 2.69 |
| 8 | 2.21 | 1.90 |
| 9 | 0.44 | 0.20 |
| 10 | 7.96 | 7.55 |
| 11 | 4.40 | 4.20 |
| 12 | 10.23 | 9.65 |
| 13 | 8.39 | 11.87 |
| 14 | 7.80 | 13.40 |
| 15 | 9.47 | 9.13 |
| 16 | 10.50 | 10.56 |
| 17 | 6.48 | 6.66 |
| 18 | 9.71 | 10.14 |

The various film samples were also subjected to a scoring evaluation based upon their characteristics and previously noted testing results in Tables 18-25. Scores of 1-5 were assigned with the higher number being considered better, and a summary of this scoring evaluation is presented in Tables 26 and 27:

TABLE 26
Scoring of Films Formed From Trial Compositions

| | PVDF | | | Acrylic Resin | | | Acrylic level | | Edenol | Plasticizer Type | Santicizer |
|---|---|---|---|---|---|---|---|---|---|---|---|
| | RF330 | RF7202 | 2899 | 2008 | B-72 | 25 | 30 | 35 | 9790 | Paraplex A-8210 | Platinum P1400 |
| Blocking | 3 | 1 | 3 | 5 | 1 | 3 | 2 | 1 | 3 | 5 | 1 |
| Tensile | 1 | 3 | 2 | 1 | 3 | 5 | 3 | 1 | 3 | 1 | 2 |
| Elongation | 1 | 3 | 2 | 1 | 3 | 3 | 2 | 1 | 1 | 3 | 5 |
| 60 Degree Gloss | 1 | 3 | 2 | 1 | 3 | 3 | 2 | 1 | 3 | 1 | 2 |
| 20 Degree Gloss | 1 | 3 | 1 | 2 | 3 | 2 | 3 | 1 | 2 | 3 | 1 |
| Ink Adhesion | 1 | 3 | 1 | 2 | 3 | 3 | 2 | 1 | 2 | 3 | 1 |
| Adhesive Adhesion | 1 | 3 | 1 | 5 | 3 | 3 | 1 | 2 | 1 | 5 | 4 |
| Sum | 9 | 19 | 12 | 17 | 19 | 22 | 15 | 8 | 15 | 21 | 16 |

TABLE 27
Scoring of Films Formed From Trial Compositions

| | Plasticizer | | | | Pigment to | | | | | | | |
|---|---|---|---|---|---|---|---|---|---|---|---|---|
| | Level | | | | Binder Ratio | | | Size Type | | | Size level | |
| | 5 | 10 | 20 | 0 | 0.5 | 1 | RA68040 | RA2899 | RA2614 | 100HK | 150HK | 200HK |
| Blocking | 2 | 1 | 1 | 1 | 1 | 1 | 3 | 5 | 1 | 1 | 2 | 3 |
| Tensile | 5 | 4 | 1 | 3 | 1 | 2 | 3 | 1 | 2 | 3 | 1 | 2 |
| Elongation | 1 | 3 | 5 | 4 | 5 | 1 | 2 | 3 | 1 | 2 | 1 | 3 |
| 60 Degree | 3 | 5 | 1 | 5 | 1 | 3 | 3 | 1 | 2 | 3 | 2 | 1 |
| Gloss | | | | | | | | | | | | |
| 20 Degree | 1 | 5 | 3 | 5 | 1 | 3 | 3 | 1 | 5 | 2 | 3 | 1 |
| Gloss | | | | | | | | | | | | |
| Ink | 2 | 5 | 1 | 4 | 5 | 1 | 4 | 1 | 5 | 1 | 2 | 3 |
| Adhesion | | | | | | | | | | | | |
| Adhesive | 3 | 5 | 1 | 3 | 2 | 1 | 3 | 2 | 1 | 2 | 1 | 3 |
| Adhesion | | | | | | | | | | | | |
| Sum | 17 | 28 | 13 | 25 | 16 | 12 | 21 | 14 | 17 | 14 | 12 | 16 |

From the results of this testing, several conclusions can be reached. Regarding Factor A (PVDF type): The PVDF copolymer RF7202 was the best choice for producing a free standing film with regard to all evaluated properties except for blocking. It should be noted that a film using no plasticizer was also evaluated via the blocking test, and that film did not block. Regarding Factor B (Acrylic type): B-72 was best overall, while 2008 was best for blocking, no doubt due to the glass transition temperature (Tg) difference of the two resins. Regarding Factor C (Acrylic resin level): The lower the acrylic resin level, the better. Concerning Factor D (Plasticizer Type): The Paraplex A-8210 was best overall. For Factor E (Plasticizer level): 10 PPHR was best overall. However, for this particular evaluation, 5 PPHR was too much. Without being limited to any particular amounts, it is believed that the minimum level of plasticizer necessary will be between 0 and 5 PPHR. Regarding Factor F (Pigment level): Basically, the lower the pigment to binder ratio, the better. And for, Factors G and H (Size Type and Size level): The RA68040 acrylic adhesive would be the best using a 200HK level. However, this would only be needed for a homopolymer system. For a copolymer system, no size is needed for either the ink adhesion or the adhesive adhesion.

In another group of evaluations, another collection of trial compositions were prepared. Various compositions were prepared as set forth below in Table 28:

TABLE 28
Varying Proportions and Types of Components in Compositions

| | Factor | | | | |
|---|---|---|---|---|---|
| Label | Name | Level 1 | Level 2 | Level 3 | Level 4 |
| A | Plasticizer | 1 | 2 | 3 | 4 |
| | level % | | | | |
| B | Plasticizer | Paraplex | Edenol 9790 | | |
| | Type | A-8210 | | | |
| C | Acrylic | 2043 | B72 | | |
| | Type | | | | |
| D | CAB 381.5 | 0 | 5 | | |
| E | Dispersion | Solsperse | Kspers 131 | | |
| | Aid | 32000 | | | |

In Table 28, the various components are as previously described. The reference to “CAB 381.5” is cellulose acetate butyrate from Eastman.

Using the proportions and types of components in Table 28, eight (8) trial compositions were prepared as summarized in Table 29:

TABLE 29
Summary of Trial Compositions

| Trial | A | B | C | D | E |
|---|---|---|---|---|---|
| 1 | 1 | 1 | 1 | 1 | 1 |
| 2 | 1 | 2 | 2 | 2 | 2 |
| 3 | 2 | 1 | 1 | 2 | 2 |
| 4 | 2 | 2 | 2 | 1 | 1 |
| 5 | 3 | 1 | 2 | 1 | 2 |
| 6 | 3 | 2 | 1 | 2 | 1 |
| 7 | 4 | 1 | 2 | 2 | 1 |
| 8 | 4 | 2 | 1 | 1 | 2 |

Specific amounts or levels of the various components in each of the trial compositions are set forth below in Table 30:

TABLE 30
Amounts of Components in Trial Compositions

| | | | Paraplex | Edenol | | | CAB | Solsperse | Kspers | |
|---|---|---|---|---|---|---|---|---|---|---|
| TRIAL | MPK | CYC | A-8210 | 9790 | 2043 | B-72 | 381-.5 | 32000 | 131 | RF7202 |
| 1 | 135 | 135 | 1 | | 25 | | 0 | 0.82 | | 75 |
| 2 | 135 | 135 | | 1 | | 25 | 5 | | 0.66 | 75 |
| 3 | 135 | 135 | 2 | | 25 | | 5 | | 0.66 | 75 |
| 4 | 135 | 135 | | 2 | | 25 | 0 | 0.82 | | 75 |
| 5 | 135 | 135 | 3 | | | 25 | 0 | | 0.66 | 75 |
| 6 | 135 | 135 | | 3 | 25 | | 5 | 0.82 | | 75 |
| 7 | 135 | 135 | 4 | | | 25 | 5 | 0.82 | | 75 |
| 8 | 135 | 135 | | 4 | 25 | | 0 | | 0.66 | 75 |

In Table 30 above, “CAB 381-5” is cellulose acetate butyrate from Eastman Chemical. That component can be utilized as a blocking agent. The other components are described herein.

Films were formed from the trial compositions and then subjected to various testing and evaluations: blocking at 140° F. for 24 hours, tensile testing, elongation testing, 60 degree gloss, adhesion to adhesive, tensile testing after one week at 160° F., elongation testing after one week at 160° F., 60 degree gloss after one week at 160° F. tensile shock testing, percent strain at break shock testing, elongation shock, and blocking at 140° F. for 24 hours. The results of these tests are presented in Tables 31-42 as follows.

TABLE 31
Blocking at 140° F. for 24 Hours

| Trial | Blocking Rating (Higher is Better) |
|---|---|
| 1 | 8.00 |
| 2 | 8.00 |
| 3 | 5.00 |
| 4 | 7.00 |
| 5 | 8.00 |
| 6 | 7.00 |
| 7 | 8.00 |
| 8 | 1.00 |

TABLE 32
Tensile Testing (in PSI)

| | Tensile PSI |
|---|---|
| Trial | (Higher is Better) |
| 1 | 1,836.00 |
| 2 | 1,767.00 |
| 3 | 2,349.00 |
| 4 | 1,690.00 |
| 5 | 1,672.00 |
| 6 | 2,200.00 |
| 7 | 1,723.00 |
| 8 | 1,992.00 |

TABLE 33
Elongation

| | % Elongation |
|---|---|
| Trial | (Higher is Better) |
| 1 | 56.36 |
| 2 | 78.28 |
| 3 | 40.52 |
| 4 | 44.75 |
| 5 | 74.71 |
| 6 | 36.82 |
| 7 | 60.41 |
| 8 | 22.80 |

TABLE 34
60 Degree Gloss

| | 60 Degree Gloss |
|---|---|
| Trial | (Higher is Better) |
| 1 | 36.90 |
| 2 | 35.80 |
| 3 | 35.90 |
| 4 | 45.40 |
| 5 | 32.10 |
| 6 | 45.00 |
| 7 | 39.90 |
| 8 | 50.60 |

TABLE 35
Adhesion to Adhesive

| | Adhesion to Adhesive |
|---|---|
| Trial | (Higher is Better) |
| 1 | 2.97 |
| 2 | 7.50 |
| 3 | 8.10 |
| 4 | 3.50 |
| 5 | 8.00 |
| 6 | 6.70 |
| 7 | 4.50 |
| 8 | 1.50 |

TABLE 36
Tensile Testing After One Week at 160° F. (in PSI)

| Trial | Tensile (Higher is Better) |
|---|---|
| 1 | 4,045.00 |
| 2 | 3,681.00 |
| 3 | 4,448.00 |
| 4 | 3,226.00 |
| 5 | 3,127.00 |
| 6 | 4,291.00 |
| 7 | 3,074.00 |
| 8 | 2,573.00 |

TABLE 37
Elongation After One Week at 160° F.

| Trial | % Elongation (Higher is Better) |
|---|---|
| 1 | 8.50 |
| 2 | 18.00 |
| 3 | 6.50 |
| 4 | 14.30 |
| 5 | 24.20 |
| 6 | 2.60 |
| 7 | 22.10 |
| 8 | 1.10 |

TABLE 38
60 Degree Gloss After One Week at 160° F.

| Trial | 60 Degree Gloss |
|---|---|
| 1 | 32.60 |
| 2 | 38.80 |
| 3 | 31.80 |
| 4 | 38.40 |
| 5 | 32.10 |
| 6 | 36.80 |
| 7 | 34.20 |
| 8 | 21.90 |

TABLE 39
Tensile Shock Testing (in PSI)

| | | Shock Test |
|---|---|---|
| Trial | Tensile | (Higher is Better) |
| 1 | 5,097.00 | 4,971.00 |
| 2 | 3,949.00 | 4,357.00 |
| 3 | 5,549.00 | 4,474.00 |
| 4 | 4,395.00 | 4,032.00 |
| 5 | 3,767.00 | 3,383.00 |
| 6 | 4,389.00 | 4,507.00 |
| 7 | 3,833.00 | 4,123.00 |
| 8 | 1,597.00 | 1,200.00 |

TABLE 40
Strain at Break Shock Test (in %)

| | | Shock Test |
|---|---|---|
| Trial | Tensile | (Higher is Better) |
| 1 | 45.50 | 62.70 |
| 2 | 71.10 | 67.70 |
| 3 | 37.50 | 37.00 |
| 4 | 45.30 | 46.40 |
| 5 | 63.90 | 71.40 |
| 6 | 40.10 | 39.60 |
| 7 | 63.60 | 60.60 |
| 8 | 30.00 | 30.00 |

TABLE 41
Elongation Shock Test

| | |
|---|---|
| | Elongation Shock Test |
| Trial | (Higher is Better) |

| | | |
|---|---|---|
| 1 | 23.10 | 31.80 |
| 2 | 36.10 | 34.37 |
| 3 | 19.00 | 18.70 |
| 4 | 23.00 | 23.60 |
| 5 | 32.47 | 36.27 |
| 6 | 20.36 | 21.80 |
| 7 | 32.30 | 30.70 |
| 8 | 15.00 | 15.00 |

TABLE 42
Blocking at 140° F. for 24 Hours

| Trial | Blocking (Higher is Better) |
|---|---|
| 1 | 1.00 |
| 2 | 6.00 |
| 3 | 2.00 |
| 4 | 3.00 |
| 5 | 4.00 |
| 6 | 1.00 |
| 7 | 6.00 |
| 8 | 1.00 |

The various film samples were then scored based upon their characteristics and the previously noted testing results presented in Tables 31-42. Scores of 1-7 were assigned with the higher number being considered better, and a summary of this scoring evaluation is presented in Table 43:

TABLE 43
Scoring of Films Formed from Trial Compositions

| | Plasticizer level (%) | | | | Plasticizer Type | | Acrylic Type | | CAB 381.5 | | Dispersion Aid | Kspers |
|---|---|---|---|---|---|---|---|---|---|---|---|---|
| | 1 | 2 | 3 | 4 | Paraplex A-8210 | Edenol 9790 | 2043 | B-72 | 0 | 5 | Solsperse 32000 | 131 |
| Blocking | 7 | 3 | 5 | 1 | 2 | 1 | 1 | 3 | 1 | 2 | 3 | 1 |
| Blocking BB | 2 | 1 | 1 | 2 | 2 | 1 | 1 | 3 | 1 | 3 | 1 | 2 |
| Tensile | 1 | 7 | 5 | 3 | 1 | 2 | 4 | 1 | 1 | 3 | 1 | 2 |
| Elongation | 7 | 3 | 5 | 1 | 3 | 1 | 1 | 4 | 1 | 2 | 1 | 2 |
| Heat Aged Gloss | 7 | 6 | 5 | 1 | 1 | 2 | 1 | 3 | 1 | 2 | 3 | 1 |
| Tensile Shock Test | 6 | 7 | 4 | 1 | 2 | 1 | 1 | 2 | 1 | 2 | 3 | 1 |
| % Strain Break Shock | 7 | 1 | 5 | 3 | 2 | 1 | 1 | 3 | 1 | 2 | 1 | 2 |
| % Elongation Shock test | 7 | 1 | 4 | 3 | 2 | 1 | 1 | 3 | 1 | 2 | 1 | 2 |
| Adhesion to Adhesive | 3 | 5 | 7 | 1 | 2 | 1 | 1 | 2 | 1 | 3 | 1 | 3 |
| 60 Degree Gloss | 1 | 5 | 3 | 7 | 1 | 4 | 3 | 1 | 2 | 1 | 2 | 1 |
| Heat Aged tensile | 7 | 6 | 4 | 1 | 2 | 1 | 3 | 1 | 1 | 3 | 2 | 1 |
| Heat Aged Elongation | 4 | 1 | 3 | 2 | 3 | 1 | 1 | 4 | 1 | 2 | 1 | 2 |
| Sum | 59 | 46 | 51 | 26 | 23 | 17 | 19 | 30 | 13 | 27 | 20 | 20 |

In this series of evaluations, it appears that a plasticizer level of 1% to 3% is best for use with a PVDF copolymer. The Paraplex A-8210 plasticizer was slightly better than the Edenol 9790. However, either plasticizer could be used for most applications. Regarding the type of acrylic component, B-72 produced better results than the 2043 component. This is believed to result from the B-72 material having a lower glass transition temperature (Tg) than that for the 2043 material. Generally, the presence of a supplemental resin such as cellulose acetate butyrate is beneficial such as shown by incorporating the CAB 381.5.

Many other benefits will no doubt become apparent from future application and development of this technology.

All patents, applications, standards, and articles noted herein are hereby incorporated by reference in their entirety.

As described hereinabove, the present subject matter solves many problems associated with previous compositions, films, strategies, systems or devices. However, it will be appreciated that various changes in the details, materials and arrangements of components and operations, which have been herein described and illustrated in order to explain the nature of the subject matter, may be made by those skilled in the art without departing from the principle and scope of the subject matter, as expressed in the appended claims.

What is claimed is:

1. A composition comprising:
from 50% to 99% of at least one polyvinylidene fluoride polymer;
from 1% to 50% of at least one acrylic component;
from 0% to 5% of at least one supplemental resin;
from 0% to 15% of at least one plasticizer; and
an effective amount of solvent.

2. The composition of claim 1 wherein the amount of the polyvinylidene fluoride polymer is from 60% to 90%.

3. The composition of claim 1 wherein the amount of the at least one acrylic component is from 10% to 40%.

4. The composition of claim 1 wherein the amount of the supplemental resin is from about 1% to 5%.

5. The composition of claim 1 wherein the amount of the plasticizer is from about 0% to 10%.

6. The composition of claim 1 wherein the amount of the polyvinylidene fluoride polymer is from 65% to 85%.

7. The composition of claim 1 wherein the amount of the acrylic component is 15% to 35%.

8. The composition of claim 1 wherein the amount of the supplemental resin is from 1% to 3%.

9. The composition of claim 1 wherein the amount of plasticizer is from 1% to 10%.

10. The composition of claim 1 additionally comprising up to 25% pigment.

11. The composition of claim 1 wherein the composition comprises at least one crosslinking agent.

12. The composition of claim 1 wherein the composition is free of crosslinking agents.

13. A method for forming a polyvinylidene fluoride film, the method comprising:
providing a composition including from 50% to 99% of at least one polyvinylidene fluoride polymer, from 1% to 50% of at least one acrylic component, from 0% to 5% of at least one supplemental resin, from 0% to 15% of at least one plasticizer, and an effective amount of solvent;
providing a substrate defining at least one face;
forming a layer of the composition on the face of the substrate;
performing at least one of drying and fusing of the layer to thereby form the polyvinylidene fluoride film.

14. The method of claim 13 wherein the drying or fusing is performed by heating to a temperature of from 280° F. to 370° F.

15. The method of claim 14 wherein the heating is performed for a time period of from 1 minute to 5 minutes.

16. The method of claim 13 further comprising:
removing the film from the substrate to thereby obtain an unsupported film.

17. The method of claim 16 further comprising:
winding the unsupported film in a roll.

18. The method of claim 13 wherein the thickness of the layer of the composition is from 0.1 mil to 5 mil.

19. A polyvinylidene fluoride film produced by the method of claim 13.

20. The film of claim 19 wherein the film has a thickness of 0.1 mil to 3 mil.

21. The film of claim 19 wherein the film is free of a carrier or support.

22. The film of claim 19 wherein the film can undergo an elongation of up to 5% without breaking or fracturing.

23. The film of claim 22 wherein the film can undergo an elongation of up to 25% without breaking or fracturing.

24. The film of claim 23 wherein the film can undergo an elongation of up to 50% without breaking or fracturing.

25. The film of claim 24 wherein the film can undergo an elongation of up to 100% without breaking or fracturing.

26. An unsupported film free of a carrier, the film including a cured composition, the composition prior to curing having from 50% to 99% of at least one polyvinylidene fluoride polymer and from 1% to 50% of at least one acrylic component, wherein the film has a thickness in a range of from 0.1 mil to 5 mil and can undergo an elongation of up to 5% without breaking or fracturing.

27. The unsupported film of claim 26 wherein the film can undergo an elongation of up to 25% without breaking or fracturing.

28. The unsupported film of claim 27 wherein the film can undergo an elongation of up to 50% without breaking or fracturing.

29. The unsupported film of claim 28 wherein the film can undergo an elongation of up to 100% without breaking or fracturing.

30. The unsupported film of claim 26 wherein the amount of the polyvinylidene fluoride polymer is from 60% to 90%.

31. The unsupported film of claim 26 wherein the amount of the acrylic component is from 10% to 40%.

32. The unsupported film of claims 26 wherein the composition further has from 1% to 5% of a supplemental resin.

33. The unsupported film of claim 26 wherein the composition further has from 0.1% to 10% of plasticizer.

34. The unsupported film of claim 26 wherein the composition further has from 0.1% to 25% pigment.

35. The unsupported film claim 26 wherein the film is crosslinked.

36. The unsupported film of claim 26 wherein the film is free of crosslinking agents.
